(19) United States
(12) Patent Application Publication
(10) Pub. No.: US 2014/0236904 A1
(43) Pub. Date: Aug. 21, 2014

(54) BATCH ANALYSIS

(71) Applicant: VERIZON PATENT AND LICENSING INC., Basking Ridge, NJ (US)

(72) Inventors: Shankar KUPPUSWAMY, Clarksville, MD (US); Cedric PERSAUD, Silver Spring, MD (US); Nicholas M. NEGELEIN, Tulsa, OK (US)

(73) Assignee: VERIZON PATENT AND LICENSING INC., Basking Ridge, NJ (US)

(21) Appl. No.: 13/771,765

(22) Filed: Feb. 20, 2013

(51) Int. Cl. G06F 17/30

(52) U.S. Cl. CPC G06F 17/30303
USPC 707/690

(57) ABSTRACT

A computing device is configured to receive a parameter from a user device. The parameter may include a requirement for a batch, stored by the computing device, to properly process batch information. The computing device is configured to test the batch by using the parameter to generate a test result before processing the batch information; and store the test result.

### BACKGROUND

A scheduling application may be used to schedule the sending of multiple data files from one computing device to another computing device. The multiple (e.g., 1,000, 10,000, 100,000, etc.) data files may also be known as batch information. The batch information may be processed by a batch that is stored by the computing device. The batch may include one or more commands, scripts, programs, codes, and/or other types of functions.

### BRIEF DESCRIPTION OF DRAWINGS

FIG. 1 is a diagram of an overview of an implementation described herein;

FIG. 2 is a diagram of an example environment in which systems and/or methods described herein may be implemented;

FIG. 3 is a diagram of example components of one or more devices of FIG. 1 and FIG. 2;

FIG. 4 is a flow chart of an example process for configuring parameters;

FIG. 5 is a flow chart of an example process for determining whether a batch satisfies the requirements of different parameters; and

FIGS. 6A-6B are diagrams of an example process for determining whether a batch satisfies the requirements of different parameters.

### DETAILED DESCRIPTION OF PREFERRED EMBODIMENTS

The following detailed description refers to the accompanying drawings. The same reference numbers in different drawings may identify the same or similar elements.

A computing device may have a batch that is used to process batch information. The batch may include errors and may not process the batch information correctly. The errors may be associated with commands missing from the batch, improper levels of access for different users using the batch, and/or other types of errors. Systems and/or methods described herein may test the batch and determine any errors associated with the batch before the computing device receives and processes the batch information. If there are any errors in the batch, a user, of the computing device, may correct the errors before the computing device receives and processes the batch information.

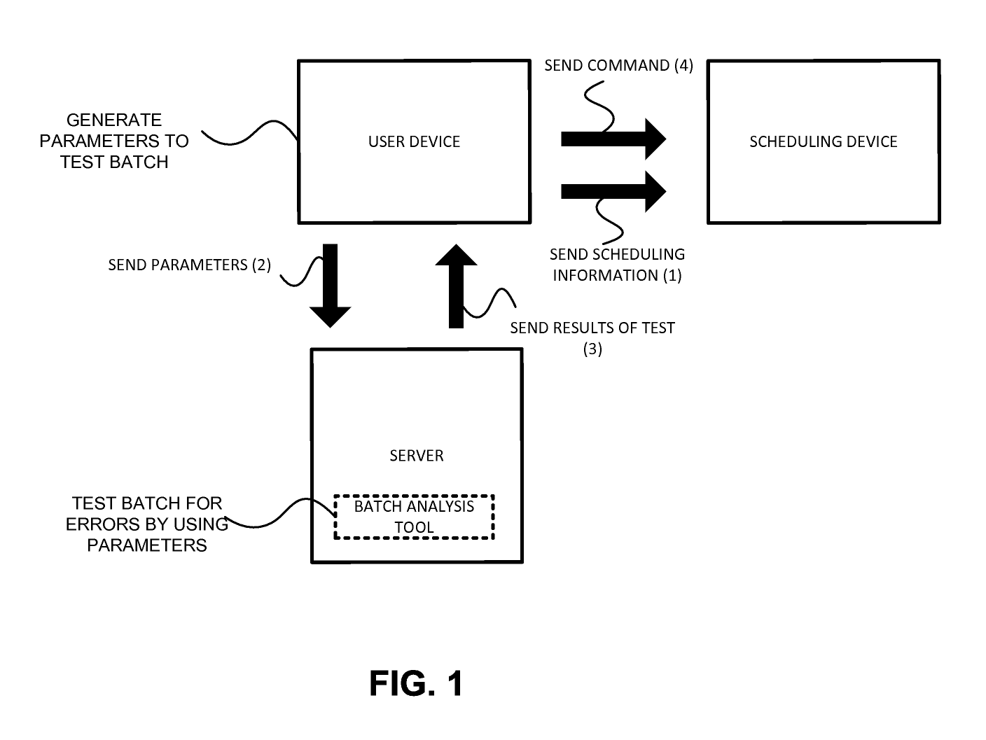

FIG. 1 is a diagram of an overview of an implementation described herein. As shown in FIG. 1, a user device may be used to generate and send scheduling information to a scheduling device (see communication (1)). The scheduling device may use the scheduling information to schedule the sending of batch information to the server. Before the scheduling device executes the scheduling information to send the batch information to the server, the user device may generate parameters that are to be used by a batch analysis tool (stored by the server) to test a batch to determine whether the batch is capable of processing the batch information. The batch may include one or more commands, scripts, and/or other functions that are stored by the server. For example, the parameters may be used by the batch analysis tool to test the batch and determine whether a particular command (e.g., edit command, execute command, etc.), needed to process the batch information, is included in the batch. The parameters may be sent to the batch analysis tool, as shown in FIG. 1 (see communication (2)). The batch analysis tool may use the parameters to test the batch stored by server.

As shown in FIG. 1, the batch analysis tool may send results of the test to the user device (see communication (3)). If there are no errors, the user device may send a command to the scheduling device (see communication (4)) for the scheduling device to execute the scheduling information and to send the batch information to the server. If there is an error in the batch, the user device may communicate with the server (or another computing device) to correct the error in the batch.

As a result, the batch analysis tool may be able to discover errors in the batch before batch information is processed by the batch. By testing the batch, the errors associated with the batch may be reduced and the efficiency associated with scheduling and sending the batch may be increased.

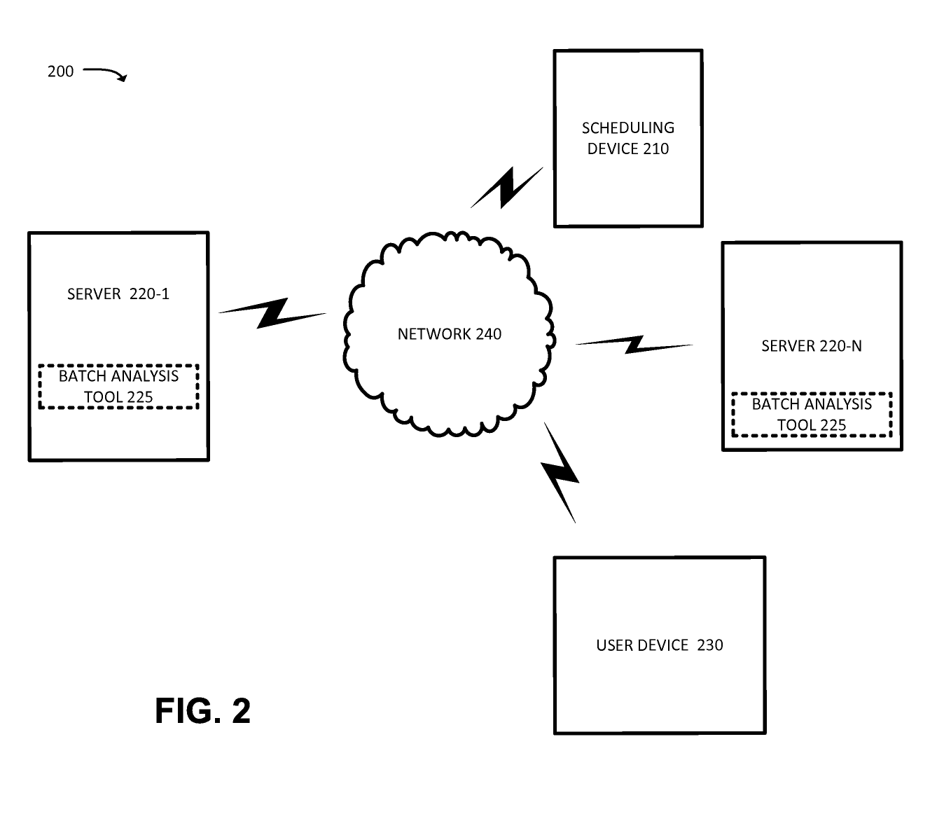

FIG. 2 is a diagram of an example environment 200 in which systems and/or methods described herein may be implemented. As shown in FIG. 2, environment 200 may include a scheduling device 210, servers 220-1, . . . , 220-N (N≧1) (referred to generally as “servers 220” and individually as “server 220”), a batch analysis tool 225, a user device 230, and a network 240.

Scheduling device 210 may include one or more computing devices that process, manage, and/or schedule batch information for processing by a batch on a server 220. Scheduling device 210 may include a scheduling application that schedules batch information to be processed by a server 220. The scheduling application may be configured by scheduling client software executed by user device 230.

Server 220 may include one or more server devices that send/receive batch information. Server 220 may receive instructions from scheduling device 210 regarding when to process batch information. Server 220 may include a batch, which when executed by server 220, may be used to process batch information received by server 220.

Batch analysis tool 225 may include an application that tests a batch stored by server 220. Batch analysis tool 225 may use parameters to test the batch to determine whether the batch has any errors before the batch is used to process batch information.

User device 230 may include any computation or communication device that is capable of generating parameters that may be used by batch analysis tool 225 to test a batch. For example, user device 230 may include a personal computer, a laptop, a workstation, or another computation or communication device. User device 230 may also interact with scheduling device 210 to schedule the processing of batch information by a server 220.

Network 240 may include a cellular network, a public land mobile network (PLMN), a second generation (2G) network, a third generation (3G) network, a fourth generation (4G) network, a fifth generation (5G) network, and/or another network. Additionally, or alternatively, network 240 may include a local area network (LAN), a wide area network (WAN), a metropolitan network (MAN), a telephone network (e.g., the Public Switched Telephone Network (PSTN)), an ad hoc network, an intranet, the Internet, a satellite network, a global positioning system (“GPS”) network, a fiber optic-based network, and/or a combination of these or other types of networks. Additionally, or alternatively, network 240 may support secure communications via a private network (e.g., a virtual private network (VPN) or a private IP VPN (PIP VPN)), and/or secure communications via a public network.

The quantity of devices and/or networks, illustrated in FIG. 2, is provided for explanatory purposes only. In practice, there may be additional devices and/or networks; fewer devices and/or networks; different devices and/or networks; or differently arranged devices and/or networks than illustrated in FIG. 2. Also, in some implementations, one or more of the devices of environment 200 may perform one or more functions described as being performed by another one or more of the devices of environment 200. Devices of environment 200 may interconnect via wired connections, wireless connections, or a combination of wired and wireless connections.

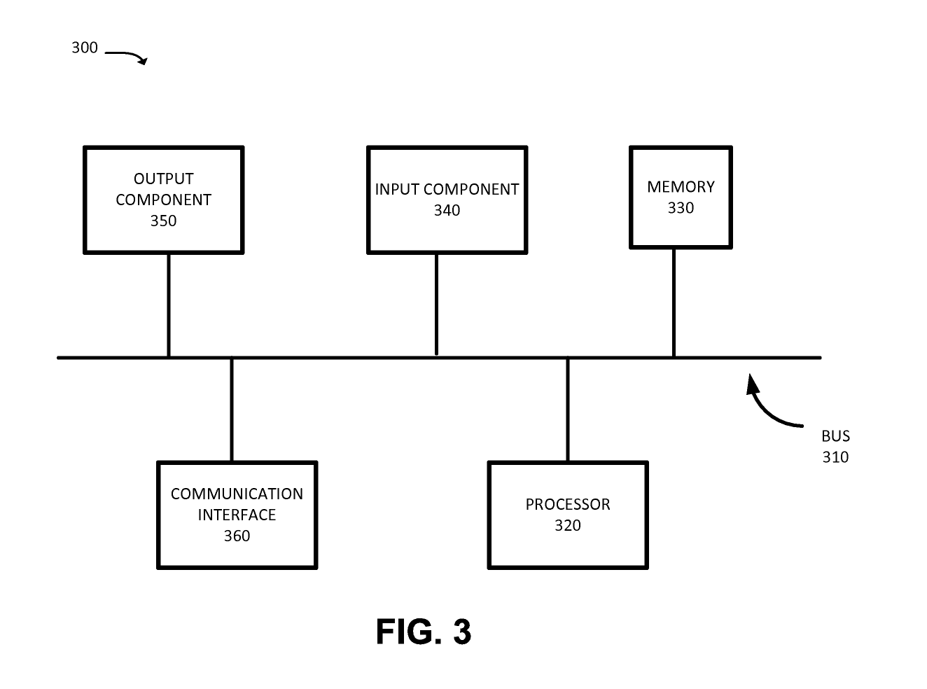

FIG. 3 is a diagram of example components of a device 300. Device 300 may correspond to scheduling device 210, server 220, and/or user device 230. Additionally, or alternatively, each of scheduling device 210, server 220, and/or user device 230 may include one or more devices 300 and/or one or more components of device 300.

As shown in FIG. 3, device 300 may include a bus 310, a processor 320, a memory 330, an input component 340, an output component 350, and a communication interface 360.

Bus 310 may include a path that permits communication among the components of device 300. Processor 320 may include one or more processors, microprocessors, or processing logic (e.g., a field programmable gate array (FPGA), or an application specific integrated circuit (ASIC)) that interprets and executes instructions. Memory 330 may include any type of dynamic storage device that stores information and instructions, for execution by processor 320, and/or any type of non-volatile storage device that stores information for use by processor 320.

Input component 340 may include a component that permits a user to input information to device 300, such as a keyboard, a keypad, a button, a switch, etc. Output component 350 may include a component that outputs information to the user, such as a display, a speaker, one or more light emitting diodes (LEDs), etc.

Communication interface 360 may include any transceiver-like mechanism that enables device 300 to communicate with other devices and/or systems. For example, communication interface 360 may include an Ethernet interface, an optical interface, a coaxial interface, a wireless interface, or the like.

In another implementation, communication interface 360 may include, for example, a transmitter that may convert baseband signals from processor 320 to radio frequency (RF) signals and/or a receiver that may convert RF signals to baseband signals. Alternatively, communication interface 360 may include a transceiver to perform functions of both a transmitter and a receiver of wireless communications (e.g., radio frequency, infrared, visual optics, etc.), wired communications (e.g., conductive wire, twisted pair cable, coaxial cable, transmission line, fiber optic cable, waveguide, etc.), or a combination of wireless and wired communications.

As will be described in detail below, device 300 may perform certain operations. Device 300 may perform these operations in response to processor 320 executing software instructions (e.g., computer program(s)) contained in a computer-readable medium, such as memory 330, a secondary storage device (e.g., hard disk, CD-ROM, etc.), or other forms of RAM or ROM. A computer-readable medium may be defined as a non-transitory memory device. A memory device may include space within a single physical storage device or spread across multiple physical storage devices. The software instructions may be read into memory 330 from another computer-readable medium or from another device. The software instructions contained in memory 330 may cause processor 320 to perform processes described herein. Alternatively, hardwired circuitry may be used in place of or in combination with software instructions to implement processes described herein. Thus, implementations described herein are not limited to any specific combination of hardware circuitry and software.

While FIG. 3 shows device 300 as having a particular quantity and arrangement of components, in other implementations, device 300 may contain fewer components, additional components, different components, or differently arranged components than depicted in FIG. 3. Additionally, or alternatively, one or more components of device 300 may perform one or more tasks described as being performed by one or more other components of device 300.

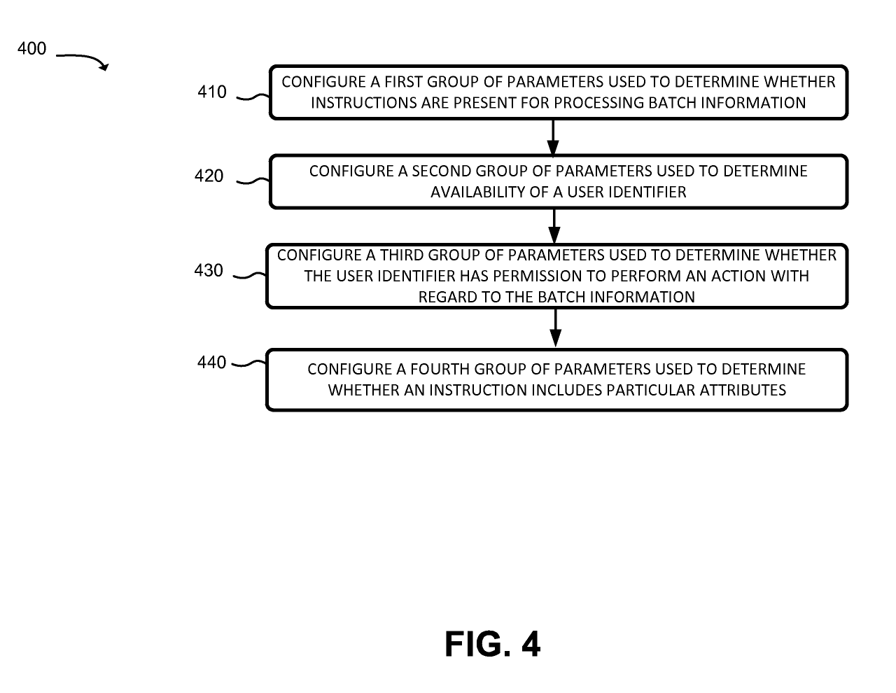

FIG. 4 is a flow chart of an example process 400 for configuring parameters. In one implementation, process 400 may be performed by user device 230. In another example implementation, one or more blocks of process 400 may be performed by one or more other devices, such as scheduling device 210 and/or server 220.

Process 400 may include configuring a first group of parameters used to determine whether instructions are present for processing batch information (block 410). For example, a user, using user device 230, may configure a first group of parameters to be used by batch analysis tool 225 to test a batch (stored by server 220) for the presence of particular instructions, within the batch, needed to process the batch information. Instructions, as used herein, may include particular commands, programs, codes, and/or scripts.

The instructions within the batch may be used to edit, execute, and/or perform other actions relating to processing batch information. If, for example, the batch is associated with billing information, then there may be instructions associated with processing the billing information. This may include instructions associated with editing the billing information, calculating billing values, retrieving billing information from a data structure, and/or other types of operations.

The user may, for example, use a graphical user interface to configure the first group of parameters. The graphical user interface may be associated with batch analysis tool 225. The graphical user interface may display information to the user of user device 230 by using text, images, icons, windows, colors, thumbnails, and/or other data within the graphical user interface. For example, the graphical user interface may display a list of instructions that are associated with a particular type of batch. The graphical user interface may have options available for the user of user device 230 to select which instructions will be tested by batch analysis tool 225.

User device 230 may send the first group of parameters to batch analysis tool 225 (stored by server 220). Batch analysis tool 225 may use the first group of parameters to test the batch to determine whether the batch includes particular instructions.

Process 400 may include configuring a second group of parameters used to determine the availability of a user identifier (block 420). For example, the user, of user device 230, may configure the second group of parameters to be used by batch analysis tool 225 to determine whether a batch includes a particular user identifier that is needed to process the batch information. The user, of user device 230, may, for example, select one or more user identifiers (e.g., identification information, such as name, number, or another type of identifier) from a list of user identifiers displayed by the graphical user interface (described with regard to block 410). The selection of user identifiers from the list may be included in the second group of parameters.

User device 230 may send the second group of parameters to batch analysis tool 225. Batch analysis tool 225 may use the second group of parameters to determine whether the user identifier's available for use by the batch. For example, batch analysis tool 225 may determine whether the user identifier is included in a list of available user identifiers.

Process 400 may include configuring a third group of parameters used to determine whether the user identifier has permission to perform an action with regard to the batch information (block 430). For example, the user, using the graphical user interface (described with regard to block 410), may configure the third group of parameters to be used by batch analysis tool 225 to test the batch to determine that the batch includes permission for a particular user identifier to perform batch information.

The user, of user device 230, may, using the graphical user interface, select a particular user identifier associated with server 220. The user may also select a level of permission for the particular user identifier to perform the batch information (e.g., access the batch information, process the batch information, modify the batch information, etc.) and associate the particular user identifier with the particular level of permission as one of the parameters within the third group of parameters.

User device 230 may send the third group of parameters to batch analysis tool 225 (stored by server 220). Batch analysis tool 225 may use the third group of parameters to test the batch to determine whether the batch includes permission for the user identifier to perform the batch information. For example, the third group of parameters may be used by batch analysis tool 225 to test the batch to confirm that the batch permits a user identifier to access a particular data structure, to perform a particular action with regard to the particular data structure, to modify the batch information, or the like.

Batch analysis tool 225 may identify the permissions associated with the user identifier by performing a look-up operation in a data structure that maps user identifiers to permissions. Batch analysis tool 225 may determine whether the identified permissions match the actions that the batch will perform when processing the batch information.

Process 400 may include configuring a fourth group of parameters used to determine whether an instruction includes particular attributes (block 440). For example, the user, using user device 230, may configure the fourth group of parameters to be used by batch analysis tool 225 to test the batch to determine whether an instruction includes particular attributes. For example, a particular instruction may be tested to determine that the particular instruction includes particular attributes that permit a batch to edit a script, copy a script, delete a script, execute a script, and/or perform any other type of function with regard to a script. The user may, using the graphical user interface (described with regard to block 410), select different attributes to be tested for a particular instruction within the batch. For example, if a batch is to modify a particular script, the user may select to test the batch to determine that the particular script has an attribute that permits the particular script to be modified.

User device 230 may send the fourth group of parameters to batch analysis tool 225. Batch analysis tool 225 may be stored by server 220. Batch analysis tool 225 may use the fourth group of parameters to test the batch.

While process 400 has been described with regard to four different groups of parameters, the user of user device 230 may configure additional types of parameters to be used by batch analysis tool 225 to test a batch stored by server 220.

While a series of blocks has been described with regard to FIG. 4, the order of the blocks may be modified in other implementations. Further, non-dependent blocks may be performed in parallel.

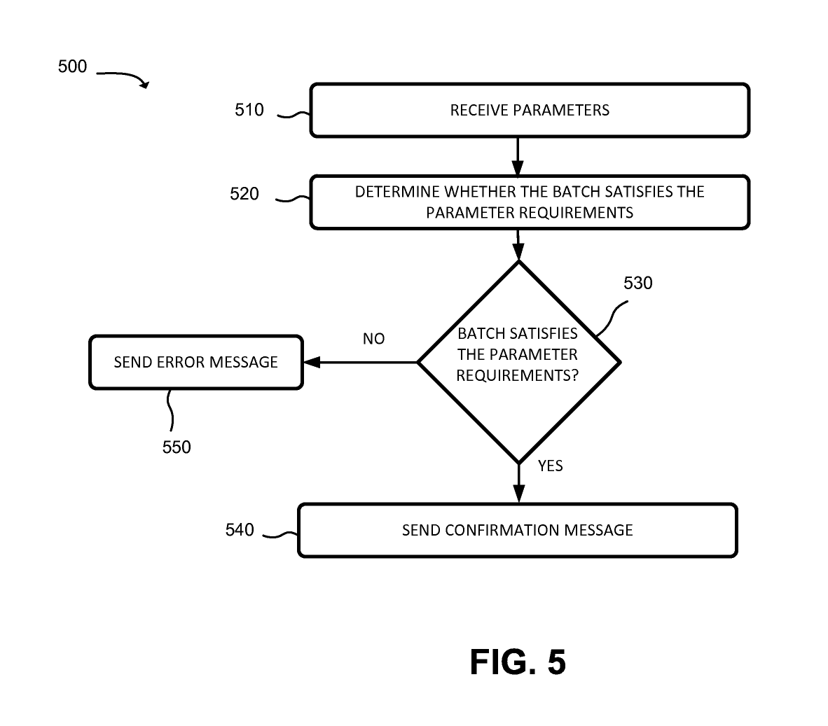

FIG. 5 is a flow chart of an example process 500 for determining whether a batch satisfies [particular parameters. In one implementation, process 500 may be performed by server 220. In another example implementation, one or more blocks of process 500 may be performed by one or more other devices, such as scheduling device 210 and/or user device 230.

Process 500 may include receiving parameters (block 510). For example, batch analysis tool 225, stored by server 220, may receive parameters from user device 230. The parameters may include the first group of parameters, the second group of parameters, the third group of parameters, the fourth group of parameters described with regard to FIG. 4. As described above, the parameters may include certain requirements used to test a batch.

In some implementations, server 220 may be selected based on a user, of user device 230, using a scheduling application to select which servers 220 are to receive and process batch information. In some implementations, server 220 may be selected by scheduling device 210. Scheduling device 210 may send a message to user device 230 (based on receiving scheduling information from user device 230 similar to that described with regard to FIG. 1) that server 220 has been selected to receive the batch information.

Process 500 may include determining whether the batch satisfies the parameter requirements (block 520). For example, batch analysis tool 225 may test the batch to determine whether the batch satisfies the parameter requirements. This may include determining whether the batch includes particular instructions needed to process the batch information; determining whether a user identifier, to be used by the batch to process the batch information, is available; determining whether a user identifier has permission to perform a particular action with regard to the batch information; and determining whether an instruction has a particular attribute that permits the batch to perform a particular action on the instruction. Batch analysis tool 225 may store the outcome of whether the batch satisfies the parameter requirements.

If the batch satisfies the parameter requirements (block 530—YES), then process 500 may include sending a confirmation message (block 540). For example, batch analysis tool 225 may send a confirmation message to user device 210 that the batch, stored by server 220, does not have any errors. Based on user device 210 receiving the confirmation message, user device 210 may send a command to scheduling device 210 to send batch information to server 220. Scheduling server 210 may receive the command and initiate the sending of batch information to server 220. The batch information may be sent from scheduling server 210 to server 220 or the batch information may be sent to server 220 from another computing device (e.g., another server 220).

Server 220 may receive the batch information and may process the batch information using the batch. For example, if the batch information is associated with billing information, the batch may, for example, process the billing information, calculate a billing value, to write a billing value to a particular data structure, to reading a billing value to a data structure, or the like.

If the batch does not satisfy the parameter requirements (block 530—NO), then process 500 may include sending an error message (block 550). For example, batch analysis tool 225 may send an error message to user device 230. The error message may include information about which one or more parameter requirements are not satisfied by the batch. The user, of user device 230, may view the error message (e.g., via a display device associated with user device 230). The user may communicate (via user device 230) with other users (who are using other user devices 230) to either inform the other users that the batch does not satisfy the parameter requirements, or the user may take additional actions (e.g., debugging the batch stored by server 220) to correct the batch so that the batch does satisfy the parameter requirements. After correcting the batch, batch analysis tool 225 may test the batch again and determine whether the batch satisfies the parameter requirements.

While a series of blocks have been described with regard to FIG. 5, the order of the blocks may be modified in other implementations. Further, non-dependent blocks may be performed in parallel.

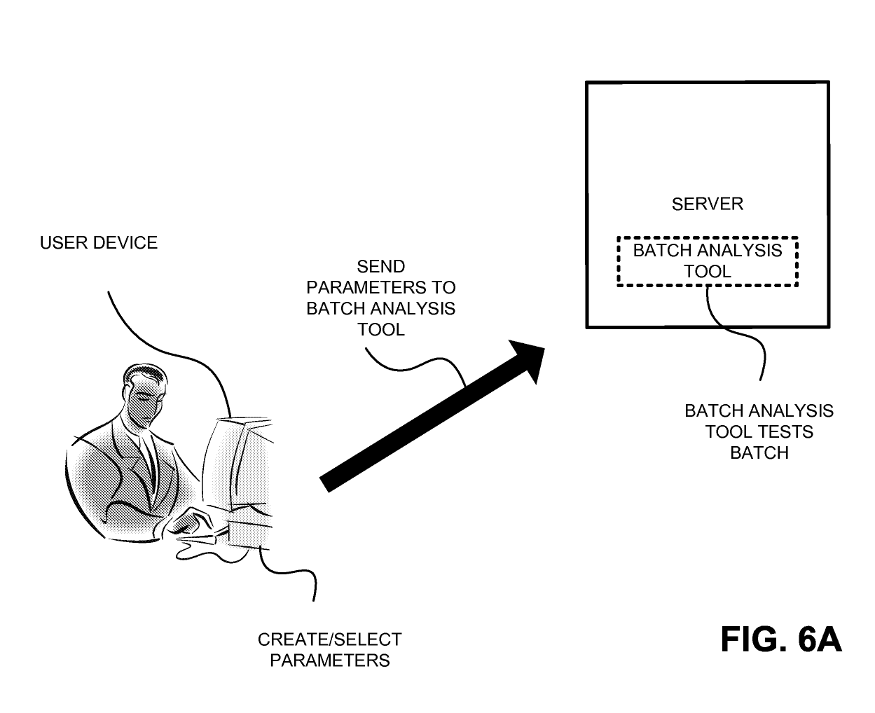

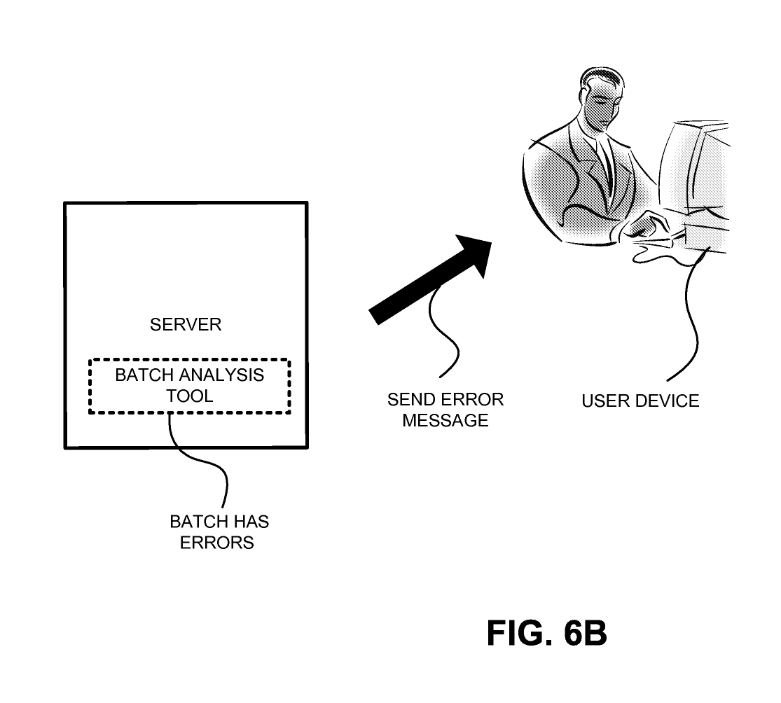

FIGS. 6A-6B are diagrams of an example process for determining whether a batch satisfies the requirements of particular parameters. As shown in FIG. 6A, a user, using a user device, may create or select parameters that are used by a batch analysis tool (stored on a server) to test a batch to determine whether the batch can properly process batch information. Assume that the user creates a first parameter that is to be used by the batch analysis tool to test a batch to determine that the batch has an edit command that is needed to process the batch information. Further assume that the user creates a second parameter that is to be used by the batch analysis tool to test the batch to determine that a particular user identifier is available, and a third parameter that is to be used by the batch analysis tool to test the batch to determine that the particular user identifier has permission to perform a particular action with regard to the batch information. The parameters may be sent from the user device to a batch analysis tool stored by a server, as shown in FIG. 6A. The batch analysis tool may test the batch stored by the server.

Assume that the batch analysis tool determines that the batch does not include an edit command and, thus, the batch does not satisfy all of the parameters. As shown in FIG. 6B, the batch analysis tool may send an error message to the user device. The user, using the user device, may use the results to initiate a process to correct the batch so that the batch includes the edit command. Once the batch is corrected, the batch analysis tool may again be used to test the batch. If the batch satisfies all of the parameters, then the server may send a message to the user device. The message may result in the server receiving and processing batch information.

As a result, the batch analysis tool may be able to discover errors in the batch before batch information is processed by the batch. By validating the batch, the errors associated with the batch may be reduced and the efficiency associated with scheduling and sending the batch may be increased.

While the above examples describe batch analysis tool 225 as using parameters for testing the batch, the terms “test” and “testing” may also include other types of analysis performed by batch analysis tool 225 on the batch.

The foregoing description of implementations provides illustration and description, but is not intended to be exhaustive or to limit the implementations to the precise form disclosed. Modifications and variations are possible in light of the above disclosure or may be acquired from practice of the implementations.

It will be apparent that example aspects, as described above, may be implemented in many different forms of software, firmware, and hardware in the implementations illustrated in the figures. The actual software code or specialized control hardware used to implement these aspects should not be construed as limiting. Thus, the operation and behavior of the aspects were described without reference to the specific software code--it being understood that software and control hardware could be designed to implement the aspects based on the description herein.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

No element, act, or instruction used in the present application should be construed as critical or essential unless explicitly described as such. Also, as used herein, the article “a” is intended to include one or more items and may be used interchangeably with “one or more.” Where only one item is intended, the term “one” or similar language is used. Further, the phrase “based on” is intended to mean “based, at least in part, on” unless explicitly stated otherwise.

What is claimed is:

1. A system comprising:
a computing device to:
receive a parameter from a user device,
the parameter including a requirement for a batch to properly process batch information,
the batch being stored by the computing device;
test the batch using the parameter;
determine, based on testing the batch, whether the batch satisfies the parameter; and
send a confirmation message to the user device based on the batch satisfying the parameter,
the confirmation message indicating that the user device can initiate scheduling of the batch information to the computing device; or
send an error message to the user device that the batch has an error based on the batch not satisfying the parameter.

2. The system of claim 1, where, when testing the batch, the computing device is to:
test the batch to determine whether the batch includes a particular instruction needed to properly process the batch information; and
where, when determining whether the batch satisfies the parameter,
the computing device is to:
determine that the batch satisfies the parameter when the batch includes the particular instruction.

3. The system of claim 1, where, when testing the batch, the computing device is to:
test the batch to determine whether a user identifier, needed by the batch to properly process the batch information, is available; and
where, when determining whether the batch satisfies the parameter,
the computing device is to:
determine that the batch satisfies the parameter when the user identifier is available.

4. The system of claim 3, where, when testing the batch, the computing device is to:
test the batch to determine whether the user identifier is permitted to perform an action that is needed to properly process the batch information; and
where, when determining whether the batch satisfies the parameter,
the computing device is to:
determine that the batch satisfies the parameter when the user identifier is permitted to perform the action.

5. The system of claim 1, where the computing device is further to:
receive, from the user device and based on the error message, a correction to the batch to form a corrected batch; and
receive and process the batch information based on the corrected batch.

6. The system of claim 1, where, when testing the batch, the computing device is to:
test the batch to determine whether an instruction, within the batch, includes an attribute that permits the batch to perform an action with regard to the instruction; and
where, when determining whether the batch satisfies the parameter,
the computing device is to:
determine that the batch satisfies the parameter when the instruction includes the attribute.

7. A method comprising:
receiving, by a computing device, a parameter from a user device,
the parameter including a requirement for a batch to properly process batch information,
the batch being stored by the computing device;
testing, by the computing device, the batch by using the parameter to generate a test result before processing the batch information; and
storing, by the computing device, the test result.

8. The method of claim 7, where testing the batch includes:
testing the batch to determine whether a user identifier, needed by the batch to properly process the batch information, is available,
the test result indicating that the batch satisfies the parameter when the user identifier is available.

9. The method of claim 8, where testing the batch includes:
testing the batch to determine whether the user identifier is permitted to perform an action with regard to the batch information,
the test result indicating that the batch satisfies the parameter when the user identifier is permitted to perform the action.

10. The method of claim 7, where testing the batch includes:
testing the batch to determine whether the batch includes a particular instruction needed to properly process the batch information,
the test result indicating that the batch does not satisfy the parameter when the batch does not include the particular instruction.

11. The method of claim 7, further comprising:
sending a confirmation message to the user device that the batch satisfies the parameter when the test result indicates that the batch satisfies the parameter;
receiving the batch information based on sending the confirmation message; and
processing the batch information using the batch.

12. The method of claim 7, further comprising:
sending an error message to the user device that the batch does not satisfy the parameter when the test result indicates that the batch does not satisfy the parameter;
receiving, based on sending the error message, a correction to the batch to form a corrected batch;
testing the corrected batch using the parameter; and
determining that the corrected batch satisfies the parameter.

13. The method of claim 7, where the instruction includes a command, a code, a script, or a program.

14. A computer-readable medium comprising:
a plurality of instruction that, when executed by one or more processors of a computing device, cause the one or more processors to:
receive a parameter from a user device,
the parameter including a requirement for a batch to properly process batch information,
the batch being stored by the computing device;
test the batch using the parameter before processing the batch information;
determine, based on testing the batch, whether the batch satisfies the parameter; and
send a message to the user device based on determining whether the batch satisfies the parameter.

15. The computer-readable medium of claim 14, where one or more instructions, of the plurality of instructions, to test the batch include one or more instructions to:
test the batch to determine whether a user identifier, needed by the batch to properly process the batch information, is available; and
where one or more instructions, of the plurality of instructions, to determine whether the batch satisfies the parameter include one or more instructions to:
determine that the batch satisfies the parameter when the user identifier is available.

16. The computer-readable medium of claim 15, where one or more instructions, of the plurality of instructions, to test the batch include one or more instructions to:
test the batch to determine whether the user identifier is permitted to perform an action that is needed to properly process the batch information; and
where one or more instructions, of the plurality of instructions, to determine whether the batch satisfies the parameter include one or more instructions to:
determine that the batch satisfies the parameter when the user identifier is permitted to perform the action.

17. The computer-readable medium of claim 14, where one or more instructions, of the plurality of instructions, to test the batch include one or more instructions to:
test the batch to determine whether the batch includes a particular command needed to properly process the batch information; and
where one or more instructions, of the plurality of instructions, to determine whether the batch satisfies the parameter include one or more instructions to:
determine that the batch satisfies the parameter when the batch includes the particular command.

18. The computer-readable medium of claim 14, where one or more instructions, of the plurality of instructions, to send the message to the user device include one or more instructions to:
send an error message to the user device based on determining that the batch does not satisfy the parameter; and
the plurality of instructions that, when executed by the one or more processors, further cause the one or more processors to:
receive, based on sending the error message, a correction to the batch to form a corrected batch; and
receive and process the batch information based on the corrected batch.

19. The computer-readable medium of claim 14, where one or more instructions, of the plurality of instructions, to test the batch include one or more instructions to:
test the batch to determine whether a script, within the batch, includes an attribute that permits the batch to perform an action with regard to the script; and
where one or more instructions, of the plurality of instructions, to determine whether the batch satisfies the parameter include one or more instructions to:
determine that the batch satisfies the parameter when the script includes the attribute.

20. The computer-readable medium of claim 14, where:
the plurality of instructions that, when executed by the one or more processors, further cause the one or more processors to:
receive the batch information based on the batch satisfying the parameter; and
process the batch information using the batch.
